(19) United States
(12) Patent Application Publication
(10) Pub. No.: US 2025/0189676 A1
(43) Pub. Date: Jun. 12, 2025

(54) SYSTEM AND METHOD FOR GLOBAL REAL-TIME KINEMATIC PRECISE POSITIONING

(71) Applicant: UTI Limited Partnership, Calgary (CA)

(72) Inventors: Zhitao LYU, Calgary (CA); Yang GAO, Calgary (CA)

(21) Appl. No.: 18/744,298

(22) PCT Filed: Nov. 30, 2022
(86) PCT No.: PCT/CA2022/051751

§ 371 Date: Jun. 14, 2024

Related U.S. Application Data
(60) Provisional application No. 63/289,970, filed on Dec. 15, 2021.

(51) Int. Cl. G01S 19/07; G01S 19/44

(52) U.S. Cl. CPC G01S 19/07; G01S 19/44

(57) ABSTRACT

System and method for geo-positioning using a plurality of chained reference stations. A user station receives station-generated correction information-that is, SSR corrections that generated by a single station and unique to that reference station and positioning information from the specific reference station. A user-positioning module of the user station processes the received positioning information, as well as the reference station's station-specific corrections, to determine the user station's location. In some embodiments, the user station receives positioning and unique correction information from multiple reference stations. The user-positioning module then fuses the received information to determine the user station's location. Additional reference stations can be added to the reference station network by propagation. The reference station's position is known to a predetermined degree of precision.

### TECHNICAL FIELD

The present invention relates to geo-positioning. More specifically, the present invention relates to a system and method for global, real-time kinematic precise positioning (GRTK).

### BACKGROUND

To better understand the present invention, the reader is directed to the listing of citations at the end of this description. For ease of reference, these citations and references have been referred to by their listing number throughout this document. The contents of the citations in the list at the end of this description are hereby incorporated by reference herein in their entirety.

Precise positioning with Global Navigation Satellite Systems (“GNSS”, including without limitation GPS, GLONASS, Galileo, and Beidou) is mainly based on the following three techniques: precise point positioning (PPP), real-time kinematics (RTK), and PPP augmented by a network of dense reference stations known as PPP-RTK.

Precise point positioning (PPP) is a well-known geo-positioning method that uses a GNSS receiver coupled with state-space-representation (SSR) corrections generated by a global network of sparsely distributed reference stations. For real-time applications, the SSR corrections can be broadcast to PPP users at a lower transmission rate than RTK. PPP can achieve decimeter to centimeter-level positioning accuracy globally using a single receiver. PPP, however, requires a comparatively long period of time before the ambiguities of the carrier phase observations can be resolved to their integer values (i.e., for ambiguity resolution, “AR”).

Another geo-positioning method, real-time kinematics (RTK), conducts precise position determination using a GNSS receiver coupled with observation-space-representation (OSR) corrections which are generated by a local reference station or by a local network of densely distributed reference stations known as network RTK (NRTK). However, the OSR corrections must be broadcast at a high transmission rate. As well, while capable of fast ambiguity resolution, unlike PPP, both RTK and NRTK are limited by short operating ranges (i.e., the user must be within the vicinity of a reference station or the area covered by the local network of reference stations). NRTK further requires a processing centre to process the GNSS network data to generate network-based OSR corrections and involves a high computational load. The high transmission rate required for OSR corrections, and the potential requirement of a processing centre, increases the system cost and limits the usability of RTK and NRTK techniques, especially when the transmission bandwidths are low (e.g., when using a radio or satellite-based communication link)

To address the shortcomings of these methods, a combined approach has been developed. This approach augments PPP using a regional network of continuously operating reference stations (CORS) to estimate network-based SSR corrections to enable fast ambiguity resolution, and is known as PPP-RTK. The reference network in PPP-RTK is used to estimate the augmentation corrections which include any combination of the ionospheric delay, tropospheric delay, satellite clock bias, satellite hardware bias and phase bias for application by the user station so that fast ambiguity resolution (AR) becomes feasible (e.g., integer ambiguities can be fixed in a few epochs).

However, the PPP-RTK approach still has several drawbacks. For example, a regional CORS network is required to generate augmentation corrections for the covered area. Such a network of spatially dense reference stations is typically costly to establish and maintain. Additionally, PPP-RTK also requires a processing center, resulting in high computational load.

Further, to reduce computational load and enhance flexibility in precise positioning techniques, cooperative GNSS positioning methods have been proposed to share key information among inter-connected GNSS receivers without the deployment of network reference station infrastructure ([4]). For example, in ([2]), stations are chained together. If the location of a rover station is determined using RTK information from other chained reference stations, it can become a RTK reference station and start providing RTK information to adjacent stations for RTK positioning. This method, however, is still conducted in the conventional OSR correction domain, and requires high bandwidth to transmit the corrections. A similar method has been used elsewhere, and a network server is required for receiving the data to generate the RTK corrections to users, which further increases the cost of the system. Further, others have proposed a method of PPP-RTK with the ionospheric and tropospheric augmentation from a single reference station. However, this method can only be used when external fractional cycle bias (FCB) product is available. Also, the long initialization time of the PPP required at the reference station further limit the usability of the method. Further, each of the above methods can only utilize the augmentation information from one reference station.

Others have shown that the convergence time of the PPP in the rover station can be significantly improved by constraining the ionospheric delay estimate using nearby receiver stations. This approach was further extended by ([3]) to constrain the tropospheric delay estimate using nearby receiver stations for PPP-RTK. While still limited by local stations or network coverage, those methods are also limited by a long initialization period necessary for the reference stations.

As such, there is a need for systems and methods that reduce and/or overcome the deficiencies of the prior art.

### SUMMARY

This document discloses a system and method for geo-positioning using a chain of reference stations. A user station receives station-specific SSR correction information—that is, SSR corrections generated at a single reference station that are unique to that single reference station—and positioning information from the specific reference station. Reference stations in this system can be any static or moving GNSS receiver capable of supporting precise positioning, provided the receiver's position is precisely known or has been precisely determined. The reference station-generated SSR corrections can support fast precise positioning at user stations with no need for conventional network-generated ambiguity-resolved SSR corrections. A user-positioning module of the user station processes the received positioning information, as well as the reference station's station-specific corrections, to determine the user station's location. In some embodiments, the user station receives positioning and unique correction information from multiple reference stations. The user-positioning module then fuses the received information to determine the user station's location. Additional reference stations can be added to the reference station network by propagation. The reference station's position is known to a predetermined degree of precision, using any suitable positioning method.

In a first aspect, this document discloses a system for determining locations, said system comprising: a plurality of reference stations, and a user station, said user station comprising: a receiving module for receiving information from at least one reference station of said plurality of reference stations; and a user-positioning module for determining a location of said user station, wherein said information comprises station-generated correction information, said station-generated correction information being unique to said at least one reference station, wherein a position of said at least one reference station is determined to a predetermined degree of precision, and wherein said determining of said location of said user station is based on said station-generated correction information.

In another embodiment, this document discloses a system wherein said station-specific correction information comprises state-space representation (SSR) corrections for said at least one reference station.

In another embodiment, this document discloses a system wherein said at least one reference station is mobile

In another embodiment, this document discloses a system wherein said at least one reference station is stationary.

In another embodiment, this document discloses a system wherein said position of said at least one reference station is determined using precise point positioning (PPP).

In another embodiment, this document discloses a system wherein said position of said at least one reference station is determined using correction information from other reference stations.

In another embodiment, this document discloses a system wherein said user station receives further correction information from multiple reference stations.

In another embodiment, this document discloses a system wherein said user station further comprises a fusing module for fusing said further correction information to thereby produce fused information, and wherein said user-positioning module determines said location based on said fused information.

In another embodiment, this document discloses a system wherein said plurality of reference stations provides global coverage.

In another embodiment, this document discloses a system wherein said reference station is at least, but not limited to, one of: a dedicated GNSS receiver; a GNSS receiver of a consumer product; a GNSS receiver mounted on a vehicle; and a GNSS receiver of a consumer electronic device.

In another embodiment, this document discloses a system wherein said vehicle is an Unmanned Aerial Vehicle (UAV).

In a second aspect, this document discloses a method for determining locations, said method comprising: receiving, at a user station, information from at least one reference station from a plurality of reference stations; and based on said information, determining a location of said user station, wherein said information comprises station-generated correction information for said at least one reference station, said station-generated correction information being unique to said at least one reference station, and wherein a position of said at least one reference station is determined to a predetermined degree of precision.

In another embodiment, this document discloses a method wherein said station-specific correction information comprises state-space representation (SSR) corrections.

In another embodiment, this document discloses a method wherein said reference station is mobile.

In another embodiment, this document discloses a method wherein said reference station is stationary.

In another embodiment, this document discloses a method wherein said position of said reference station is determined using precise point positioning (PPP).

In another embodiment, this document discloses a method wherein said position of said at least one reference station is determined using correction information from other reference stations.

In another embodiment, this document discloses a method wherein said location of said user station is based on corrections from multiple reference stations.

In another embodiment, this document discloses a method wherein said plurality of reference stations provides global location coverage.

In another embodiment, this document discloses a method wherein said reference station comprises at least, but not limited to, one of: a dedicated GNSS receiver; a GNSS receiver of a consumer product; a GNSS receiver mounted on a vehicle; and a GNSS receiver of a consumer electronic device.

In another embodiment, this document discloses a method wherein said vehicle is an Unmanned Aerial Vehicle (UAV).

In a third aspect, this document discloses non-transitory computer-readable media having encoded thereon computer-readable and computer-executable instructions that, when executed, implement a method for determining locations, said method comprising: receiving, at a user station, information from at least one reference station from a plurality of reference stations; and based on said information, determining a location of said user station, wherein said information comprises station-generated correction information for said at least one reference station, said station-generated correction information being unique to said reference station, and wherein a position of said at least one reference station is determined to a predetermined degree of precision.

### BRIEF DESCRIPTION OF THE DRAWINGS

The present invention will now be described by reference to the following figures, in which identical reference numerals refer to identical elements and in which:

FIG. 1 is a schematic of a system comprising a single reference station and a user station, according to an aspect of the present invention;

FIG. 2 is a schematic of a system comprising multiple reference stations and a user station, according to an aspect of the present invention;

FIG. 3 is a schematic image of a global system according to one embodiment of the invention;

FIG. 4A is a schematic image of a part of a process flow used by the embodiment of FIG. 3;

FIG. 4B is a schematic image of another part of the process flow according to the embodiment of FIG. 4A;

FIG. 4C is a schematic image of another part of the process flow according to the embodiment of FIG. 4A;

FIG. 5 is a schematic image of a process flow for generation of fused SSR corrections;

FIG. 6 is a schematic distribution of reference stations around a user/rover station;

FIG. 7 is a schematic diagram of a propagation method for adding reference stations to the system;

FIG. 8 is a flowchart detailing a method according to one aspect of the invention; and

FIG. 9 is a flowchart detailing a method according to another embodiment of the invention.

### DETAILED DESCRIPTION

This document discloses a system and method for geo-positioning using PPP-RTK with a chain of reference stations that overcomes the deficiencies of the prior art. Specifically, this document discloses a system that generates correction information using real-time undifferenced and uncombined GNSS observations at a single reference station-that is, generating station-specific corrections that are unique to a single reference station, rather than corrections over multiple stations or over a CORS network. The positioning information generated by a specific reference station, as well as its station-specific corrections, are then passed to a user station. The user station processes the received positioning information as well as the reference station's station-specific corrections, to determine the user station's location. The station-specific corrections can also be referred to as SSR corrections (i.e., state-space-representation corrections). In some embodiments, the user station receives positioning and unique correction information from multiple reference stations and fuses the received information to determine its location.

Compared to conventional approaches to geo-positioning, the system and method disclosed herein enable high accuracy and fast convergence of real-time PPP-RTK for both multi-frequency and single-frequency users, and has several other advantages over the conventional techniques. First, the approach disclosed herein is highly flexible in terms of baseline length between stations. Second, the approach disclosed herein does not require high data transmission rates/bandwidth, as individual reference stations simply send individual data directly to a user station. Third, the approach disclosed herein can be used with any number of reference stations. That is, additional reference stations can be added to the system relatively easily and do not require centralized oversight/control/communication, unlike with a CORS network, or a computationally expensive data processing center. Further, the approach disclosed herein eliminates the need for establishment and maintenance of a permanently deployed network of dense GNSS reference stations, reduces system requirements on sampling rate of GNSS data at reference stations and time delay of transmitting reference station-generated SSR corrections to user stations, and supports fast precise positioning at user stations with no requirement for convergence at the reference stations. As such, the system disclosed herein enables global coverage and significant improvement in scalability and flexibility for the development and implementation of precise positioning systems and services at low-cost for mass-market applications.

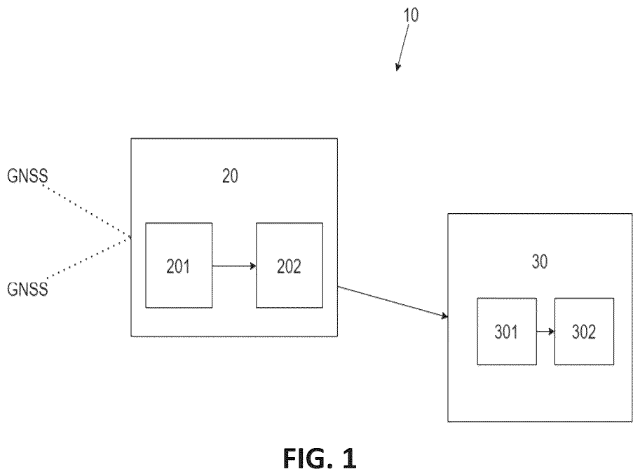

Referring now to FIG. 1, a schematic diagram of a system according to one aspect of the invention is shown. The system 10, in one embodiment, comprises at least one reference station 20 and a user station 30. The reference station 20 is presented as a single reference station for simplicity in this image; however, as should be understood, the reference station 20 is part of a chain of other reference stations 20, as will be further described below. The reference station 20 receives GNSS data from one or more GNSS networks/providers/satellite sources. As should be clear, the depiction of two GNSS sources in this FIG. 1 is purely exemplary and should not be construed as limiting the invention in any way.

The reference station 20 comprises a positioning module 201, for receiving the GNSS data and conducting a positioning process (i.e., determining the position of the reference station 20 to a predetermined degree of precision). In one embodiment, such a positioning module uses PPP to determine the position of the reference station 20. In other embodiments, where the reference station 20 receives station-generated corrections from other reference stations 20 in the chain of reference stations, the positioning module 201 uses the station-generated corrections as described herein to determine the position of the reference station 20. The reference station 20 also comprises a correction generation module 202 for generating SSR/station-specific corrections information, as will be further described below. The positioning information and corrections information for the reference station 20 is then passed to the user station 30.

The user station 30 comprises a receiving module 301 (i.e., a GNSS receiver) for receiving information from the reference station 20. The user station 30 also comprises a user-positioning module 302 for determining the location of the user station 30 based on the information received from the reference station 20 (i.e., based on both the positioning information and the station-specific correction information, as further described below).

The reference station 20 can comprise any GNSS receiver that is capable of supporting the desired positioning method (e.g., PPP). That is, the reference station 20 can comprise a dedicated GNSS receiver, a GNSS receiver of a consumer product, a GNSS receiver mounted on a vehicle/Unmanned Aerial Vehicle (UAV), a GNSS receiver of a consumer electronic device, and any other suitable GNSS receiver. For clarity, the reference station 20 can comprise a stationary/non-mobile reference station (such as a GNSS receiver integrated with a fixed antenna) and/or a mobile or non-stationary receiver (such as a GNSS receiver on a vehicle). Additionally, in embodiments with multiple reference stations 20, some of the reference stations 20 can be mobile while other reference stations 20 can be non-mobile. Mobile reference stations 20 can further be moving (i.e., in active motion) or at rest while conducting positioning processes according to the disclosures herein, as the station-specific corrections can account for movement of the reference station 20.

Similarly, the user station 30 can comprise any device capable of receiving and processing geo-locating information, including GNSS-capable consumer products and/or consumer electronics, GNSS-capable vehicles, including without limitation land vehicles, water vehicles, and/or aerial vehicles, including both manned or unmanned vehicles, and/or any other suitable device/receiver.

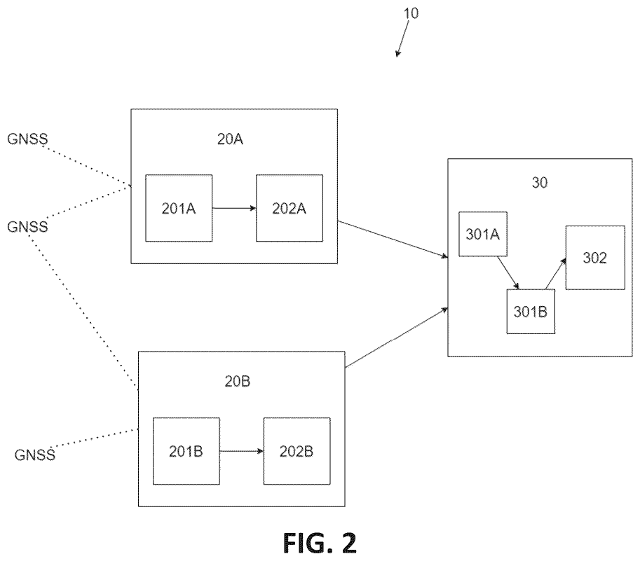

FIG. 2 is a schematic image of an embodiment of the system in FIG. 1. In this embodiment, the system 10 comprises multiple reference stations 20A and 20B. These reference stations 20A and 20B, as should be clear, are each similar to the reference station 20 of FIG. 1. That is, reference station 20A comprises a positioning module 201A and a correction generation module 202A for generating station-specific correction information that is unique to reference station 20A. Similarly, reference station 20B comprises a positioning module 201B and a correction generation module 202B for generating station-specific correction information that is unique to reference station 20B.

As should be clear, two reference stations 20 are depicted in this schematic image for simplicity. Nothing in this figure should be construed as limiting the number of reference stations 20 that may be comprised by the system 10. Similarly, the number of GNSS sources on the left of this figure (i.e., three) should not be construed as limiting the invention in any way. Further, it is not necessary for reference stations to share a GNSS source. That is, regardless of the depicted dotted lines/data transmission paths to the reference stations 20A and 20B, there is no requirement for reference stations to receive GNSS data from a single GNSS source. The number of GNSS sources is not limited in any way by the disclosures herein. Similarly, GNSS sources may operate at any suitable frequency. As well, as described above, any or all of the reference stations 20 can be stationary, moving, mobile, or non-mobile.

Additional reference stations can be added to the system by the propagation of corrections information from pre-existing reference stations, as will be described further below.

The user station 30 in FIG. 2 comprises a receiving module 301A, which is similar to the receiving module 301 in FIG. 1, except that the receiving module 301A receives information from the multiple reference stations 20A and 20B. However, the user station 30 in FIG. 2 also comprises a fusion module 301B for fusing corrections information received from the multiple reference stations 20A and 20B. A fusion process that can be used in some embodiments is described further below. The user station 30 in FIG. 2 further comprises a user-positioning module 302, which is similar to that in FIG. 1, except that the user-positioning module 302 in FIG. 2 receives fused corrections data

It should be clear that various aspects of the present invention may be implemented as software modules in an overall software system. As such, the present invention may thus take the form of computer-executable instructions that, when executed, implement various software modules with predefined functions, such as the modules described above. Further, it should be clear that the above modules can be implemented in various ways. In particular, in some embodiments, multiple ‘modules’ associated with each reference station or with each user station can be implemented together as a single module. For instance, in some embodiments, the receiving module 301A and the fusion module 301B can be implemented as a single module. Alternatively, the fusion module 301B and the user-positioning module 302 can be implemented as a single module. Any and all such combinations are intended to fall within the scope of the invention disclosed herein.

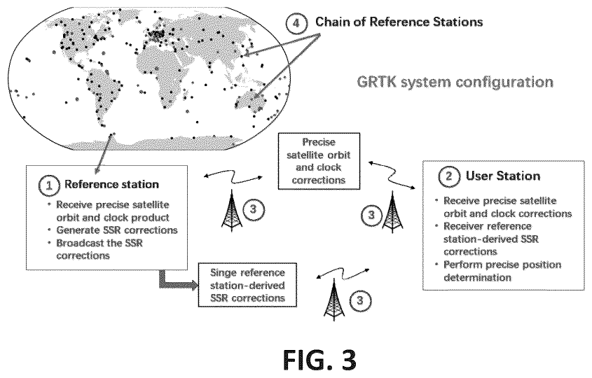

FIG. 3 shows a schematic image of a global system 10 according to the disclosures herein. That is, the system in FIG. 3 comprises many reference stations 20, distributed around the globe and thus providing global coverage for the geo-positioning network. The reference stations 20 communicate (individually and directly) with the user stations using conventional communications infrastructure (represented in this image as radio towers, but not limited thereto). Similarly, for propagation purposes, each reference station 20 communicates with other reference stations 20 using the pre-existing and/or conventional communications infrastructure.

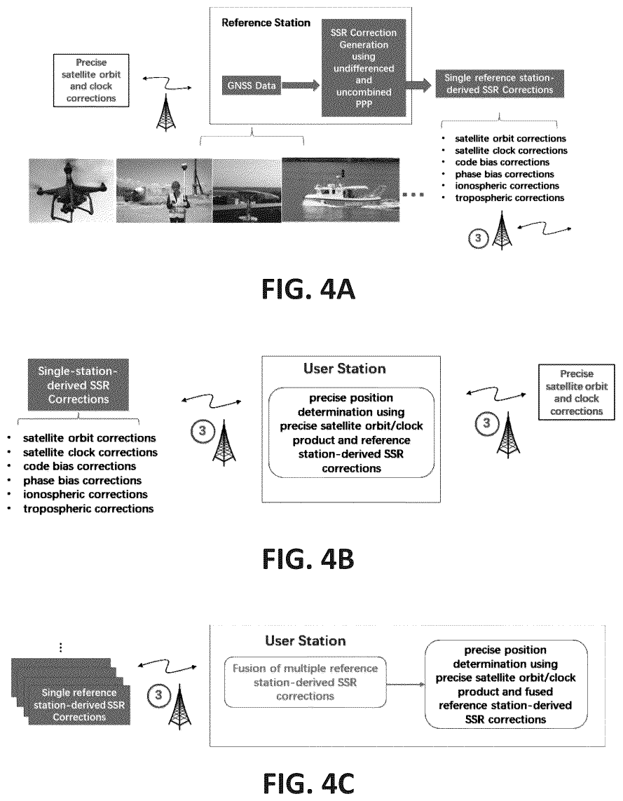

FIGS. 4A, 4B, and 4C show a general schematic process flow between different components of a system 10 according to the disclosures herein. As shown in FIG. 4A, at least one reference station uses precise satellite orbit and clock data from an external source, and GNSS data, to precisely determine its position using undifferenced and uncombined PPP. The at least one reference station then generates station-specific correction information (i.e., station-generated SSR corrections). These station-generated SSR corrections are passed to a user station, which also receives precise satellite orbit and clock data from an external source. As shown in FIG. 4B, the user station uses the reference station-generated SSR corrections and the precise satellite orbit and clock data to determine its own location. Further, as shown in FIG. 4C, the user station in some embodiments receives reference station-generated SSR corrections from multiple reference stations and fuses those corrections before determining its own location.

### Model Using Station-Specific (Undifferenced and Uncombined) Corrections Information

Generating station-specific SSR corrections is described in the following section. In one embodiment, generating such information uses undifferenced and uncombined PPP, which is known in the art. With this model, the first-order ionospheric delay can be estimated or directly corrected if the precise ionospheric delay product is available. The undifferenced uncombined model yields higher flexibility in processing GNSS observations from multiple frequencies than the ionosphere-free (IF) combinations model.

In general, station-specific correction information relates to at least one of the following: satellite orbital parameters, satellite clock parameters, atmospheric parameters related to the specific reference station, including without limitation ionospheric and tropospheric parameters, satellite phase biases related to the specific reference station, or satellite code biases. The station-generated correction information can comprise, depending on the embodiment, data on phase biases and/or ionospheric and/or tropospheric delays (in any suitable direction, such as ionospheric delays in the slant or vertical direction, tropospheric delays in the slant direction, and/or a tropospheric zenith delay). Ionospheric delays and phase biases are reference-station specific—i.e., they contain reference-station-specific biases that cannot be separated out using the estimation method. The following addresses the generation of various possible forms of correction information.

In one embodiment, undifferenced and uncombined PPP generated at a single reference station, as described above, is used to generate SSR corrections. The observation model for undifferenced and uncombined PPP can be written as equations (1) and (2), below. Where real-time precise satellite orbital/clock corrections are available, the slant ionospheric delay, tropospheric delay and ambiguity can be estimated precisely.

$${P}_{i , I}^{s} = r + ( {dt}_{I} - {dT}_{I}^{s} ) + {d}_{orb} + {M}^{s} {d}_{trop} + \frac{{λ}_{i}^{2}}{{λ}_{1}^{2}} {d}_{iono , I} + ε ( {P}_{i}^{s} ) \qquad ( 1 )$$

$${L}_{i}^{s} = r + ( {dt}_{I} - {dT}_{I}^{s} ) + {d}_{orb} + {M}^{s} {d}_{trop} - \frac{{λ}_{i}^{2}}{{λ}_{1}^{2}} {d}_{iono , I} + {λ}_{i} {N}_{i}^{s} + ε ( {L}_{i}^{s} ) \qquad ( 2 )$$

where P_{i,I}^{s}, Lᵢ^{s} are the Differential Code Bias (DCB)-corrected and the hydrostatic tropospheric delay-corrected GNSS pseudorange and phase observations for satellite s at frequency i; ε(·) is the observation noise; r is realistic effect and antenna phase center bias and variation corrected satellite to receiver distance; dT_{I}^{s}, dt_{I} are the satellite clock bias and receiver clock biases; d_{orb}, dₜᵣₒₚ are orbital, zenith wet tropospheric errors; b_{Pi}^{r}, b_{Pi}^{s} are the receiver and satellite pseudorange hardware biases; b_{Li}^{r}, b_{Li}^{s} are receiver and satellite phase hardware biases; M^{s} represents wet tropospheric mapping function; d_{iono,I} is the estimated ionospheric delay; Nᵢ^{s} and λᵢ are phase ambiguity and the phase wavelength; and PB_{i,I}^{s} is satellite phase bias.

Note that the methods described herein can be used with GNSS from GPS, Galileo, and the BEIDOU constellation. As well, the methods disclosed herein can also be applied to GNSS data from the GLONASS constellation when inter-frequency bias is properly compensated for.

The satellite phase bias can be calculated using equation (3Error! Reference source not found [symbol] ), where Z(*) rounds * to the nearest integer.

$${PB}_{i , I}^{s} = {N}_{i}^{s} - Z ( {N}_{i}^{s} ) \qquad ( 3 )$$

### Fusion of Correction Information from Multiple Reference Stations

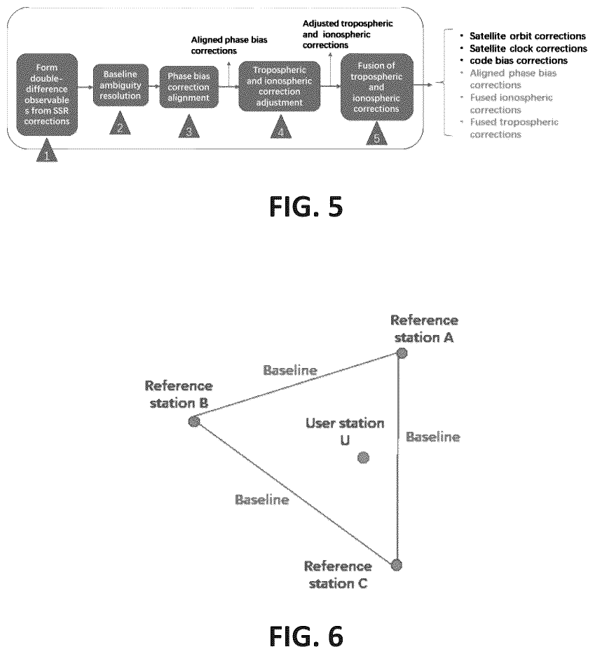

In general, fusing SSR corrections from multiple reference stations can be performed as in FIG. 5. Note that the corrections from the different reference stations 20 cannot be directly linearly combined, as the corrections from the different reference stations 20 contain different prior-convergence estimate errors. As such, the corrections must be aligned with each other before fusion can be performed.

As shown in FIG. 5, the alignment/fusion process thus generally comprises five steps. Double-differenced observables are formed from SSR corrections from different stations. Baseline ambiguity resolution is conducted and then used for phase bias corrections alignment. After that, ionospheric corrections from different reference stations are adjusted to complete the alignment process. Once the alignment is complete, fusion of tropospheric and ionospheric SSR corrections from multiple reference stations can be conducted using a suitable model. The fusion procedure requires low computational load due to the low update rate requirement of SSR corrections.

For illustrative purposes, consider the reference station distribution shown in FIG. 6. In this figure, three reference stations surround the rover station to form three inter-reference station baseline. Of course, this distribution is purely exemplary and should not be construed as limiting the invention in any way.

### Double-Differenced Observables Computation

As the satellite orbital error, clock error, and the coordinates of station A and station B are precisely known, all the prior convergence errors only exist in the estimated tropospheric delay, ionospheric delay and the phase biases.

SSR corrections from station A and B are used to form the double-difference observables to redistribute the corrections values for station A, such that the adjusted between-satellite (satellite s and k) single-differenced SSR corrections from station A contain the same prior convergence error as those of station B. The observation model for the double-difference SSR correction redistribution can be written as equations (4) and (5):

$$\overline{{P}_{i , I , A}^{s , k} - {P}_{i , I , B}^{s , k}} = {M}_{A}^{s , k} - {M}_{B}^{s , k} {d}_{trop , B} + \frac{{λ}_{i}^{2}}{{λ}_{1}^{2}} ( - - {d}_{iono , I , B}^{s , k} ) \qquad ( 4 )$$

$$\overline{{L}_{i , A}^{s , k} - {L}_{i , B}^{s , k}} = {M}_{A}^{s , k} - {M}_{B}^{s , k} {d}_{trop , B} - \frac{{λ}_{i}^{2}}{{λ}_{1}^{2}} ( - - {d}_{iono , I , B}^{s , k} ) + {λ}_{i} ( - - {PB}_{i , I , B}^{s , k} ) \qquad ( 5 )$$

where

$$\overline{{P}_{i , I , A}^{s , k} - {P}_{i , I , B}^{s , k}} , \overline{{L}_{i , A}^{s , k} - {L}_{i , B}^{s , k}}$$

are the SSR corrections derived double-differenced pseudorange and phase observations, which can be calculated by adding up the same terms as the right part of equations (4Error! [symbol] Reference source not found.) and (5) using the station A-derived, corrections; [symbol] , [symbol] , [symbol] are the tropospheric and ionospheric parameters to be adjusted for station A; and d_{trop,B}, d_{iono,I,B}^{s,k} are the tropospheric parameter and double-difference ionospheric parameters for station B, which are set to equal to the reported values at station B.

In addition, the pseudo observation model as shown in equations (6Error! Reference source not found.) and (7Error! Reference source not found. [symbol] ) below is applied for atmospheric parameters to exploit the geospatial relevance of the atmospheric parameters between the two reference stations. The observation error covariance can be determined by some atmospheric geospatial error model.

$${d}_{iono , I , B}^{s} = + {bias}_{c}$$

$${d}_{trop , B} {d}_{trop , A}$$

where bias_{c} is the bias term for GNSS constellation c to absorb the receiver hardware bias difference between [symbol] and d_{iono,I,B}^{S}, this is required as the datum of d_{iono,I,B}^{S} and [symbol] are individually determined by the pseudorange observations of two different stations.

Of course, as should be clear, although the above equations are shown with reference to Stations A and B, any pair of stations can be substituted.

### Baseline Ambiguity Resolution

As [symbol] − [symbol] −PB_{i,I,B}^{s,k} is an integer value, well-known ambiguity resolution (AR) processes can be applied to resolve its integer ambiguity. The accuracy of the estimated [symbol] and [symbol] is thereby significantly improved.

### Phase Bias Alignment

After baseline ambiguity resolution as described above, the virtual observations model as shown in equation (8Error! Reference source not [symbol] found.) can be used for an arbitrary constraint to precisely determine the phase bias estimate for station A.

$$z = - - {PB}_{i , I , B}^{s , k} \qquad ( 8 )$$

$${C}_{z} = 1 {0}^{- 5} ( {cycle}^{2} )$$

where z is the AR-resolved integer ambiguity; and C_{z} is the pseudo-observation error covariance.

After that, the prior convergence error of the adjusted [symbol] − [symbol] is properly aligned to that of station B. As [symbol] and [symbol] are determined in differenced form, there is a common systematic bias in both. However, this bias can be neglected as it will not affect AR at the user station. That is, applying the between-satellite single-difference operation will cancel this bias out before AR.

### Tropospheric and Ionospheric SSR Correction Adjustment

The virtual observations constraint in the phase bias alignment process described above also adjusts the [symbol] , [symbol] and [symbol] , such that the prior convergence error of [symbol] and [symbol] − [symbol] are aligned with those of station B. At this point, the tropospheric and ionospheric SSR correction adjustments are completed. Further, systematic bias inside [symbol] and [symbol] can be countered by including an additional unknown parameter to absorb this bias at the user station.

### Fusion of Station-Specific SSR Corrections

Fusion of the adjusted tropospheric and ionospheric SSR corrections from multiple reference stations can be conducted using a suitable model, e.g., a linear model as shown below:

$${d}_{iono} = {cof}_{iono , 0} \cdot {lat}_{ipp} + {cof}_{iono , 1} \cdot {lon}_{ipp} + {b}_{iono , j , c} \qquad ( 9 )$$

$${d}_{trop} = {cof}_{trop , 0} \cdot lat + {cof}_{trop , 1} \cdot lon + {b}_{trop} \qquad ( 10 )$$

where dᵢₒₙₒ and dₜᵣₒₚ are the fitted ionospheric and tropospheric delay; latᵢₚₚ and lonᵢₚₚ are the latitude and longitude of the ionospheric pierce point position; coƒ_{iono, 0} and coƒ_{iono, 1} are the ionospheric coefficient to be adjusted; b_{iono,j,c} is the ionospheric bias term for constellation c at station j; lat and lon are the latitude and longitude of the reference station position; coƒ_{iono, 0}, coƒ_{iono, 1} and bₜᵣₒₚ are the tropospheric coefficient to be adjusted.

Of course, as would be understood, any suitable fusion model can be used.

### Propagation of Reference Stations

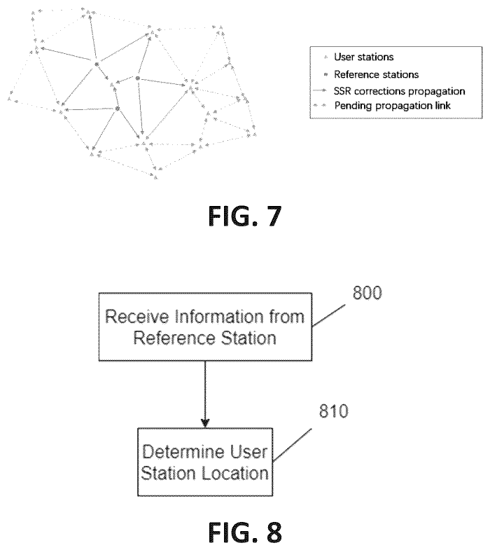

Reference stations 20 are added to the system 10 as in FIG. 7. In this figure, reference stations are shown in green. The reference stations provide SSR corrections (green arrows) to user stations (shown in yellow). As the location of each user station is precisely identified, the user stations can become new reference stations. That is, each user station potentially represents a reference station. As such, the chain of reference stations 20 can propagate indefinitely (i.e., there is no limit on the number of reference stations 20 in the chain). Static or moving reference station-derived SSR corrections enable fast ambiguity resolution for both nearby user and reference stations, providing a globally consistent coordinate frame to the chain.

### Methods According to Aspects of the Invention

Referring now to FIG. 8, a flowchart detailing a method executed by a user station according to one aspect of the invention is shown. At step 800, the user station receives information from a reference station. As described above, the information comprises station-specific correction information (i.e., correction information that is unique to the specific reference station) as well as positioning information. The user station uses the received information to determine its own location at step 810.

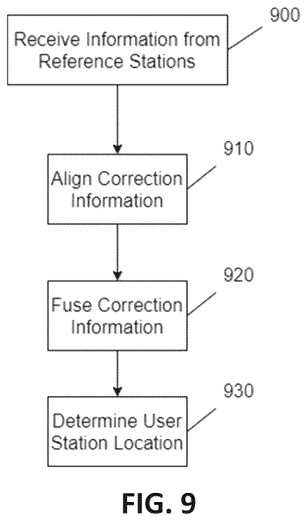

FIG. 9 is another flowchart detailing a method according to another embodiment. In this embodiment, a user station receives information from multiple reference stations at step 900. At step 910, as described above, the correction information from the different reference stations is aligned. At step 920, the correction information is fused (e.g., linearly combined), as also described above. Once the correction information has been fused, the user station can use the fused information and the positioning information from the reference stations to determine its own location at step 930.

### References

As noted above, for a better understanding of the present invention, the following references may be consulted. Each of these references is hereby incorporated herein by reference in its entirety:
1. Banville S, Collins P, Tétreault P, Lahaye F, Héroux P (2014) Precise Cooperative Positioning: A Case Study in Canada. pp 2503-2511.
2. Capua R S, O'Keefe (2021). Performance of a Collaborative Peer PPP—RTK with Ionospheric and Tropospheric Estimation Exchanges for Short-range Networks of Self-driving Users | Technical Program—ION GNSS+2021. https://www.ion.org/gnss/abstracts.cfm?paperID=10353. Accessed 20 Aug. 2021.
3. Drier S and Talbot N. Chained location determination system. (1998).
4. Garello R, Presti L L, Corazza G E, Samson J (2012) Peer-to-peer cooperative positioning. Inside GNSS, working papers: 9.
5. Lyu Z, Gao, Y (2021) PPP-RTK with Augmentation from a Single Reference Station, submitted to Journal of Geodesy, under review.
6. WO 2021/146,775 A1. WANG, Yongchao, entitled “Systems and methods for processing GNSS data streams for determination of hardware and atmosphere-delays”.
7. EP 3505965 A1. XIE, Baojun; ZHU, Feng, entitled “A positioning method and system”.

Embodiments of the invention may be executed by a computer processor or similar device programmed in the manner of method steps, or may be executed by an electronic system which is provided with means for executing these steps. Similarly, an electronic memory means such as computer diskettes, CD-ROMs, Random Access Memory (RAM), Read Only Memory (ROM) or similar computer software storage media known in the art, may be programmed to execute such method steps. As well, electronic signals representing these method steps may also be transmitted via a communication network.

Embodiments of the invention may be implemented in any conventional computer programming language. For example, preferred embodiments may be implemented in a procedural programming language (e.g., “C” or “Go”) or an object-oriented language (e.g., “C++”, “java”, “PHP”, “PYTHON” or “C #”). Alternative embodiments of the invention may be implemented as pre-programmed hardware elements, other related components, or as a combination of hardware and software components.

Embodiments can be implemented as a computer program product for use with a computer system. Such implementations may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium. The medium may be either a tangible medium (e.g., optical or electrical communications lines) or a medium implemented with wireless techniques (e.g., microwave, infrared or other transmission techniques). The series of computer instructions embodies all or part of the functionality previously described herein. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g., shrink-wrapped software), preloaded with a computer system (e.g., on system ROM or fixed disk), or distributed from a server over a network (e.g., the Internet or World Wide Web). Of course, some embodiments of the invention may be implemented as a combination of both software (e.g., a computer program product) and hardware. Still other embodiments of the invention may be implemented as entirely hardware, or entirely software (e.g., a computer program product).

A person understanding this invention may now conceive of alternative structures and embodiments or variations of the above all of which are intended to fall within the scope of the invention as defined in the claims that follow.

We claim:

1. A system for determining locations, said system comprising:
a plurality of reference stations, and
a user station, said user station comprising:
a receiving module for receiving information from at least one reference station of said plurality of reference stations; and
a user-positioning module for determining a location of said user station,
wherein said information comprises station-generated correction information, said station-generated correction information being unique to said at least one reference station,
wherein a position of said at least one reference station is determined to a predetermined degree of precision,
and wherein said determining of said location of said user station is based on said station-generated correction information.

2. The system according to claim 1, wherein said station-generated correction information comprises state-space representation (SSR) corrections for said at least one reference station.

3. The system according to claim 1, wherein said at least one reference station is mobile.

4. The system according to claim 1, wherein said at least one reference station is stationary.

5. The system according to claim 1, wherein said position of said at least one reference station is determined using precise point positioning (PPP).

6. The system according to claim 1, wherein said position of said at least one reference station is determined using correction information from other reference stations.

7. The system according to claim 1, wherein said user station receives further correction information from multiple reference stations.

8. The system according to claim 7, wherein said user station further comprises a fusing module for fusing said further correction information to thereby produce fused information, and wherein said user-positioning module determines said location based on said fused information.

9. The system according to claim 1, wherein said plurality of reference stations provides global coverage.

10. The system according to claim 1, wherein said reference station is at least one of:
a dedicated GNSS receiver;
a GNSS receiver of a consumer product;
a GNSS receiver mounted on a vehicle; and
a GNSS receiver of a consumer electronic device.

11. The system according to claim 10, wherein said vehicle is an unmanned aerial vehicle (UAV).

12. A method for determining locations, said method comprising:
receiving, at a user station, information from at least one reference station from a plurality of reference stations; and
based on said information, determining a location of said user station,
wherein said information comprises station-generated correction information for said at least one reference station, said station-generated correction information being unique to said at least one reference station,
and wherein a position of said at least one reference station is determined to a predetermined degree of precision.

13. The method according to claim 12, wherein said station-generated correction information comprises state-space representation (SSR) corrections.

14. The method according to claim 12, wherein said reference station is mobile.

15. The method according to claim 12, wherein said reference station is stationary.

16. The method according to claim 12, wherein said position of said reference station is determined using precise point positioning (PPP).

17. The method according to claim 12, wherein said position of said at least one reference station is determined using correction information from other reference stations.

18. The method according to claim 12, wherein said location of said user station is determined based on corrections from multiple reference stations.

19. The method according to claim 12, wherein said plurality of reference stations provides global coverage.

20. The method according to claim 12, wherein said reference station comprises at least one of:
a dedicated GNSS receiver;
a GNSS receiver of a consumer product;
a GNSS receiver mounted on a vehicle; and
a GNSS receiver of a consumer electronic device.

21. The method according to claim 20, wherein said vehicle is an unmanned aerial vehicle (UAV).

22. Non-transitory computer-readable media having encoded thereon computer-readable and computer-executable instructions that, when executed, implement a method for determining locations, said method comprising:
receiving, at a user station, information from at least one reference station from a plurality of reference stations; and
based on said information, determining a location of said user station,
wherein said information comprises station-generated correction information for said reference station, said station-generated correction information being unique to said reference station,
and wherein a position of said reference station is determined to a predetermined degree of precision.
